(19) United States
(12) Patent Application Publication
(10) Pub. No.: US 2011/0213597 A1
(43) Pub. Date: Sep. 1, 2011

(54) Capturing Nonlinear Deformation History

(76) Inventor: Sangpil Yoon, Campbell, CA (US)

(21) Appl. No.: 12/713,620

(22) Filed: Feb. 26, 2010

(51) Int. Cl. G06F 17/11

(52) U.S. Cl. 703/2

(57) ABSTRACT

Capturing non-linear deformation history of a material such as quartz by solving non-linear equations from the start provides for improved computational simulation of electronic devices during the design stage. In some embodiments, the process includes solving a set of non-linear equations, including a non-linear equation related to a strain characteristic of the material, a non-linear equation related to a first stress characteristic of the material, and a non-linear equation related to a second stress characteristic of the material; updating a value of the strain characteristic; and solving the set of non-linear equations to obtain a further updated value of the strain characteristic, an updated value of the first stress characteristic, and an updated value of the second stress characteristic.

### BACKGROUND

1. Field of Invention

The present application pertains to capturing non-linear deformation history of material, particularly quartz material or the like.

2. Description of Related Art

One visible consumer-driven trend in the electronics industry has been the development and manufacture of smaller devices. This miniaturization trend will likely continue, along with the demand for greater accuracy. As has also been the case, the trend will likely be coupled with reduced prices. The cost today of given amount of computer memory is much less than even a portion of that amount was a decade ago.

The miniaturization trend is not without its problems, however. One such problem pertains to drive level dependency. As frequency control devices become smaller, the effects of electrical characteristics such as frequency within the small device start to adversely affect the functionality of the device, and at some point can become significant. These effects are mainly dependent on driving power.

Still, the miniaturization trend shows no signs of abating now or in the near future. With that realization, engineers face a challenge in designing small devices; more careful consideration must be given to the effects of electrical characteristics such as frequency on such small devices. Computational simulation of devices, therefore, has become a process in today's manufacturing procedures.

Computational simulation is a substantial improvement over traditional manufacturing procedures, which typically require the building of a prototype and running various tests before mass-production of a final product. One drawback of such physical testing procedures is that they can only be performed relatively late in the development process, when fixing problems tends to be more time consuming and expensive.

Computational simulation certainly lessens this problem in that it makes it possible to identify problems well before prototypes are available. Simulation results may enable engineers to eliminate major design faults early in the life of a new design, and thereby substantially reduce the number of physical tests that are later required. Thus, computational simulation not only increases the quality of products, it also significantly reduces “design-to-manufacturing” time.

While computational simulation is an improvement over traditional manufacturing testing procedures, the drive level dependency problem persists. One shortcoming of the present approach to the problem is its treatment as a linear problem, using the linear solution as an initial value for an iteration scheme to handle non-linearity. Such an approach ignores possible non-linear material characteristics that may manifest under loading process.

### SUMMARY OF INVENTION

The inventor has discovered that a better approach to the drive level dependency problem is to treat it as non-linear from the start. Using that approach, the present invention provides a technique to capture the history of non-linear characteristics of a material such as quartz during computational simulation.

In one aspect, the invention involves a tangible medium having instructions for execution by a processor to perform a method for capturing a history of at least one non-linear characteristic of a material, which may be quartz. The instructions comprise (1) instructions for solving a set of non-linear equations, including a non-linear equation related to a strain characteristic of the material, to obtain a value of a displacement characteristic of the material at a first time and a value of a stress characteristic of the material at the first time, the first time being a non-zero time; (2) instructions for updating a value of the first strain characteristic; and (3) instructions for solving the set of non-linear equations to obtain a value of the displacement characteristic of the material at a second time and a value of the stress characteristic of the material at the second time, the second time being after the first time.

Preferably, instructions (2) and (3) are iteratively executed.

In another embodiment, instructions carried on a tangible medium for execution by a processor to perform a method for capturing a history of at least one non-linear characteristic of a material comprise (1) instructions for solving a set of non-linear equations, including a non-linear equation related to a strain characteristic of the material, a non-linear equation related to a first stress characteristic of the material, and a non-linear equation related to a second stress characteristic of the material; (2) instructions for updating a value of the strain characteristic; and (3) instructions for solving the set of non-linear equations to obtain a further updated value of the strain characteristic, an updated value of the first stress characteristic, and an updated value of the second stress characteristic.

Preferably, instructions (2) and (3) are iteratively executed.

Any of the instruction-carrying tangible mediums may be embodied in a system.

Other objects and attainments together with a fuller understanding of the invention will become apparent and appreciated by referring to the following description and claims taken in conjunction with the accompanying drawings.

### BRIEF DESCRIPTION OF DRAWINGS

In the drawings wherein like reference symbols refer to like parts.

FIG. 1 depicts a 2 cm×2 cm dimensional quartz plane and a graph of external force applied to the quartz with respect to displacement of the quartz.

FIG. 2 is a flow chart illustrating embodiments of a method of capturing the history of at least one non-linear characteristic of quartz, according to embodiments of the invention.

FIG. 3 is an illustration of a system on which at least one embodiment of the present invention may be implemented.

### DESCRIPTION OF THE PREFERRED EMBODIMENTS

In accordance with principles of the invention, the drive level dependency problem is identified, and treated from the outset, as a non-linear problem. This is consistent with the notion that, as quartz or like material that is used in substrates of electrical components reacts to external force or vibration of surface waves, the resulting deformation should continuously affect characteristics of properties of the material as the force is applied. Whether the problem is accurately characterized as linear or non-linear is determined by whether the displacement response has a linear relation to the applied external load. Assuming a driving power pseudo-statically applied to devices in simulation, as the drive level increases, the amplitude of the vibration of the quartz also increases, and the effects of non-linearities of the quartz become noticeable. Thus, the non-linear characteristics of quartz material should be accounted for from a non-linear point of view. The present invention does just that by providing a technique to capture the history of non-linear characteristics of a material such as quartz during computational simulation.

Initially, non-linear equations that may be employed in embodiments of the present invention are described.

### Non-Linear Governing Equations

In the coordinate system (X₁, X₂, X₃) with displacements (U₁, U₂, U₃), the non-linear strain-displacement relationship and other non-linear equations are given in the following general form:

(a) non-linear strain-displacement relations

$${E}_{ij} = \frac{1}{2} ( {U}_{j , i} + {U}_{i , j} + {U}_{k , i} {U}_{k , j} ) \qquad ( 1 a )$$

(b) non-linear stress-strain relations

$${T}_{ij} = {C}_{ijkl} {E}_{kl} + \frac{1}{2} {C}_{ijklmn} {E}_{kl} {E}_{mn} , \qquad ( 1 b )$$

where C is a material property constant of the quartz material

(c) non-linear stress equations of motion

(Tᵢⱼ+YⱼₖU_{i,j})_{,j}=ρÜᵢ in V (1c)

(d) traction-stress tensor relation

Pᵢ=nⱼ(Tᵢⱼ+TⱼₖU_{i,k}) on S (1d)

Equations (1c) and (1d) may be deduced from a variational principle for an elastic body of volume V and bounding surface S:

$$δ {\int }_{{t}_{0}}^{{t}_{1}} d t {\int }_{V}^{ } ( K - U ) d V + {\int }_{{t}_{0}}^{{t}_{1}} d t {\int }_{S}^{ } {P}_{i} δ {U}_{i} d S = 0 \\ K = \frac{1}{2} ρ {\dot{U}}_{i} {\dot{U}}_{i} \\ U = \frac{1}{2} {C}_{ijkl} {E}_{ij} {E}_{kl} + {C}_{ijklmn} {E}_{ij} {E}_{kl} {E}_{mn} \qquad ( 2 )$$

Using equations (1a), (1b) and (1c) and requiring δUᵢ to be zero at t₀ and t₁, yields

$$\begin{matrix}δ {\int }_{{t}_{0}}^{{t}_{1}} d t {\int }_{V}^{ } K d V = - {\int }_{{t}_{0}}^{{t}_{1}} d t {\int }_{V}^{ } ρ P {\ddot{U}}_{i} δ {U}_{i} d V \\ And & ( 3 ) \\ δ {U}_{i} = \frac{\partial U}{\partial {E}_{ij}} δ {E}_{ij} = {T}_{ij} {β}_{kj} δ {U}_{k , j} , & ( 4 )\end{matrix}$$

where βᵢⱼ, the initial deformation gradient, is given by

$${β}_{ij} = \frac{{y}_{i}}{{x}_{j}} = {δ}_{ij} + {U}_{i , j} \qquad ( 5 )$$

Substituting equations (3) and (4) into equation (2), and using the divergence theorem yields

$${\int }_{{t}_{0}}^{{t}_{1}} d t {\int }_{V}^{ } [ {( {T}_{ij} {β}_{kj} )}_{, i} - ρ {\ddot{U}}_{k} ] δ {U}_{k} d V + {\int }_{{t}_{0}}^{{t}_{1}} d t {\int }_{S}^{ } ( {P}_{k} - {n}_{i} {T}_{ij} {β}_{kj} ) δ {U}_{k} d S = 0 \qquad ( 6 )$$

### Algorithm

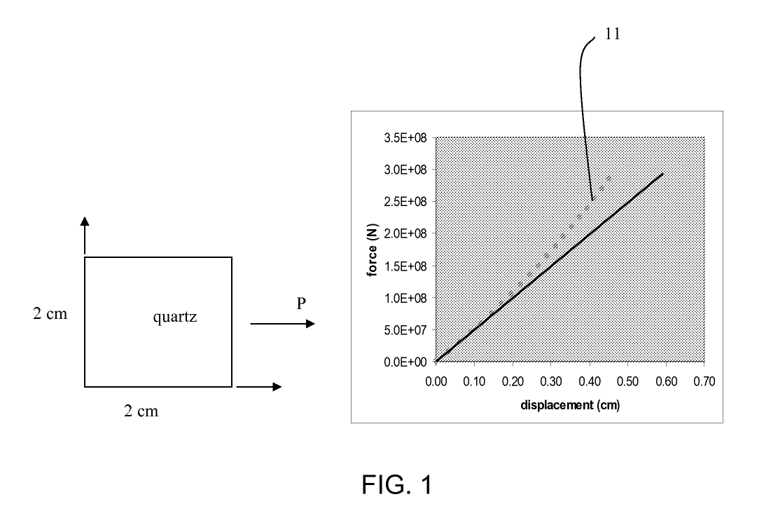

With the above equations in mind, an algorithm or method according to embodiments of the invention will now be described. The algorithm determines non-linear deformation of a material such as quartz under application of external force by solving non-linear equations from the start. The algorithm updates non-linear strain repeatedly after solving non-linear equations. Accordingly, this algorithm or method takes into account the history of reaction of the system of equations under external variations instead of jumping to an arbitrary point of the state under consideration. As can be seen from FIG. 1, force curve 11 exhibits a non-linear path during deformation of the quartz material, which path deviates from the linear significantly.

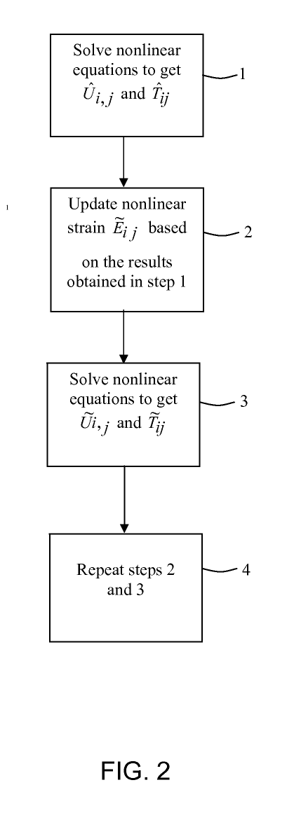

The algorithm or method is described with particular reference to the flow chart of FIG. 2. First, the following non-linear equations are solved to obtain Û_{i,j} and \hat{T}ᵢⱼ (step 1). Initially, these displacement and stress variables should be set to zero. The non-linear equations to be solved for a first non-zero time are:

$${\hat{E}}_{ij} = \frac{1}{2} ( {\hat{U}}_{j , i} + {\hat{U}}_{i , j} + {\hat{U}}_{k , i} {\hat{U}}_{k , j} )$$

$${\hat{T}}_{ij} = {C}_{ijkl} {\hat{E}}_{kl}$$

$${\hat{T}}_{ij , k} = ρ {\ddot{\hat{U}}}_{i}$$

The next step (step 2) is to update non-linear strain

$${\tilde{E}}_{ij} = \frac{1}{2} ( {\hat{U}}_{j , i} + {\hat{U}}_{i , j} + {\hat{U}}_{k , i} {\hat{U}}_{k , j} )$$

based on the results obtain from step 1.

Next, the following non-linear equations are solved to obtain Ũ_{i,j} and \tilde{T}ᵢⱼ at a second, later time (step 3).

$${\tilde{E}}_{ij} = \frac{1}{2} ( {\tilde{U}}_{j , l} + {\tilde{U}}_{i , j} + {\tilde{U}}_{k , i} {\tilde{U}}_{k , j} )$$

$${\tilde{T}}_{ij} = {C}_{ijkl} {\tilde{E}}_{kl}$$

$${\tilde{T}}_{ij , k} = ρ {\ddot{\tilde{U}}}_{i}$$

Steps 2 and 3 are repeated, preferably as long as the force is applied, to obtain a “final” solution (step 4).

### System

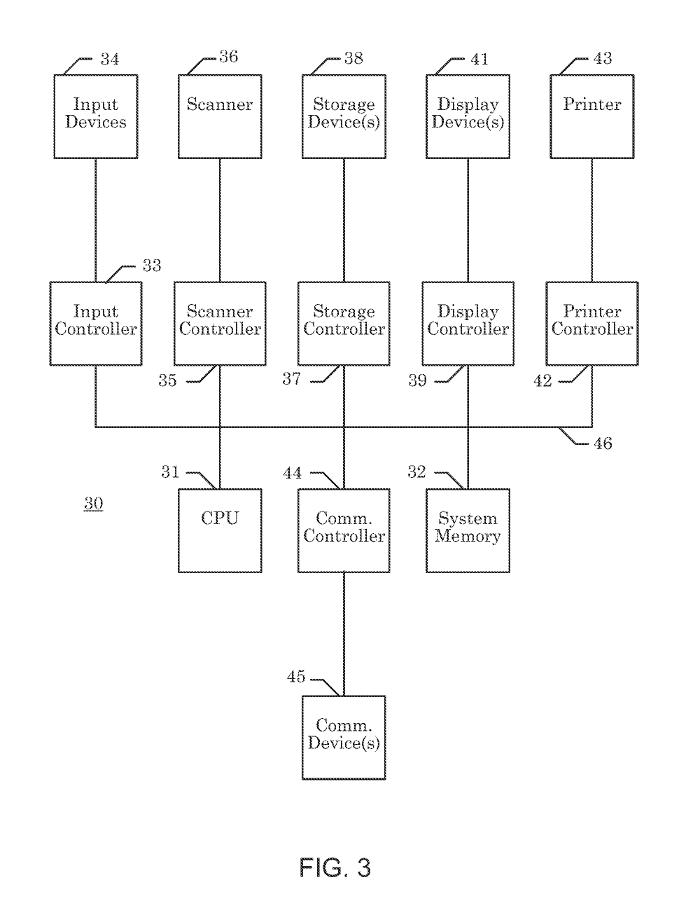

Having described the details of the invention, an exemplary system 30, which may be used to implement one or more aspects of the present invention, will now be described with reference to FIG. 3. As illustrated in FIG. 3, the system includes a central processing unit (CPU) 31 that provides computing resources and controls the computer. The CPU 31 may be implemented with a microprocessor or the like, and may also include a graphics processor and/or a floating point coprocessor for mathematical computations. The system 30 may also include system memory 32, which may be in the form of random-access memory (RAM) and read-only memory (ROM).

A number of controllers and peripheral devices may also be provided, as shown in FIG. 3. An input controller 33 represents an interface to various input device(s) 34, such as a keyboard, mouse, or stylus. There may also be a scanner controller 35, which communicates with a scanner 36. The system 30 may also include a storage controller 37 for interfacing with one or more storage devices 38 each of which includes a storage medium such as magnetic tape or disk, or an optical medium that might be used to record programs of instructions for operating systems, utilities and applications which may include embodiments of programs that implement various aspects of the present invention. Storage device(s) 38 may also be used to store processed data or data to be processed in accordance with the invention. The system 30 may also include a display controller 39 for providing an interface to a display device 41, which may be any type of known display. The system 30 may also include a printer controller 42 for communicating with a printer 43. A communications controller 44 may interface with one or more communication devices 45 that enables the system 30 to connect to remote devices through any of a variety of networks including the Internet, a local area network (LAN), a wide area network (WAN), or through any suitable electromagnetic carrier signals including infrared signals.

In the illustrated system, all major system components may connect to a bus 46, which may represent more than one physical bus. However, various system components may or may not be in physical proximity to one another. For example, input data and/or output data may be remotely transmitted from one physical location to another. In addition, programs that implement various aspects of this invention may be accessed from a remote location (e.g., a server) over a network. Such data and/or programs may be conveyed through any of a variety of machine-readable medium including magnetic tape or disk or optical disc, or a transmitter, receiver pair.

Embodiments of the present invention may be conveniently implemented with software. However, alternative implementations are certainly possible, including a hardware implementation or a software/hardware implementation. Any hardware-implemented functions may be realized using ASIC(s), digital signal processing circuitry, or the like. Accordingly, the instructions of the “tangible medium” recited in the claims may be in software or hardware, or a combination thereof. With these implementation alternatives in mind, it is to be understood that the figures and accompanying description provide the functional information one skilled in the art would require to write program code (i.e., software) or to fabricate circuits (i.e., hardware) to perform the processing required.

In accordance with further aspects of the invention, any of the above-described methods or steps thereof may be embodied in a program of instructions (e.g., software), which may be stored on, or conveyed to, a computer or other processor-controlled device for execution. Alternatively, any of the methods or steps thereof may be implemented using functionally equivalent hardware (e.g., application specific integrated circuit (ASIC), digital signal processing circuitry, etc.) or a combination of software and hardware.

While the invention has been described in conjunction with several specific embodiments, it is evident to those skilled in the art that many further alternatives, modifications, and variations will be apparent in light of the foregoing description. Thus, the invention described herein is intended to embrace all such alternatives, modifications, applications and variations as may fall within the spirit and scope of the appended claims.

What is claimed is:

1. A tangible medium having instructions for execution by a processor to perform a method for capturing a history of at least one non-linear characteristic of a material, the instructions comprising:
(1) instructions for solving a set of non-linear equations, including a non-linear equation related to a strain characteristic of the material, to obtain a value of a displacement characteristic of the material at a first time and a value of a stress characteristic of the material at the first time, the first time being a non-zero time;
(2) instructions for updating a value of the first strain characteristic; and
(3) instructions for solving the set of non-linear equations to obtain a value of the displacement characteristic of the material at a second time and a value of the stress characteristic of the material at the second time, the second time being after the first time.

2. The tangible medium of claim 1, wherein instructions (2) and (3) are iteratively executed.

3. The tangible medium of claim 1, wherein the material is quartz.

4. A system comprising the tangible medium of claim 1.

5. A tangible medium having instructions for execution by a processor to perform a method for capturing a history of at least one non-linear characteristic of a material, the instructions comprising:
(1) instructions for solving a set of non-linear equations, including a non-linear equation related to a strain characteristic of the material, a non-linear equation related to a first stress characteristic of the material, and a non-linear equation related to a second stress characteristic of the material;
(2) instructions for updating a value of the strain characteristic; and
(3) instructions for solving the set of non-linear equations to obtain a further updated value of the strain characteristic, an updated value of the first stress characteristic, and an updated value of the second stress characteristic.

6. The tangible medium of claim 5, wherein instructions (2) and (3) are iteratively executed.

7. The tangible medium of claim 5, wherein the material is quartz.

8. A system comprising the tangible medium of claim 5.
